(19) United States
(12) Patent Application Publication
(10) Pub. No.: US 2022/0302525 A1
(43) Pub. Date: Sep. 22, 2022

(54) ELECTRICITY STORAGE BATTERY AND VEHICLE EQUIPPED WITH SAID BATTERY

(71) Applicant: Faurecia Systemes D'Echappement, Nanterre (FR)

(72) Inventors: Frédéric Greber, Ecot (FR); Christophe Bouly, Bavans (FR)

(21) Appl. No.: 17/696,408

(22) Filed: Mar. 16, 2022

(30) Foreign Application Priority Data
Mar. 19, 2021 (FR) 2102776

(51) Int. Cl. H01M 10/6568; H01M 10/613; H01M 50/209

(52) U.S. Cl. CPC H01M 10/6568; H01M 10/613; H01M 50/209; H01M 10/6563

(57) ABSTRACT

A battery comprising at least one set of electricity storage cells having opposing large faces separated from each other by a gap; a plurality of separations in each gap, delimiting between them a plurality of channels for circulation of a heat transfer fluid; and a circuit for cooling the electricity storage cells. The circuit comprising a plurality of distribution channels formed between the bottom of the battery and the lower faces of the electricity storage cells. The distribution channels are configured for distributing the heat-transfer fluid in the circulation channels of all the gaps.

### CROSS REFERENCE TO RELATED APPLICATIONS

This application claims priority to and the benefit of French Patent Application Number 21 02776, filed 19 Mar. 2021, the disclosure of which is now expressly incorporated herein by reference.

### FIELD OF THE DISCLOSURE

The present disclosure relates to electricity storage batteries in generally.

### BACKGROUND

It is possible to cool the electricity storage cells of a battery by immersion in a dielectric fluid. In some systems, the heat transfer fluid circulates outside the battery, in contact with the bottom on which the electricity storage cells rest. The cooling of the electricity storage battery can be critical for certain situations in the battery life, particularly during rapid recharging.

### SUMMARY

In this context, the disclosure aims to provide an electricity storage battery that makes it possible to cool of electricity storage cells even more effectively. In some cases, one possibility is to arrange the circulation of the dielectric fluid so that it flows in contact with the three small faces of the electricity storage cells. Such a cooling method is more efficient than traditional cooling systems for electricity storage batteries.

To this end, according to a first aspect, the disclosure relates to an electricity storage battery comprising:
at least one set of electricity storage cells, each having two large faces perpendicular to a main direction and a bottom face connecting the two large faces to each other, the electricity storage cells being aligned in the main direction and forming an alignment, with two adjacent electricity storage cells in the alignment having opposite large faces separated from each other by a gap;
a plurality of separations in each gap, delimiting a plurality of channels between them for circulation of a heat transfer fluid in contact with the large faces delimiting the gap;
a bottom extending under the electricity storage cells, opposite the lower faces of the electricity storage cells;
a cooling circuit of the electricity storage cells, comprising an upstream collector and a plurality of distribution channels fluidly connected to the upstream collector, the distribution channels extending in the main direction, arranged between the bottom and lower faces of the electricity storage cells, the distribution channels distributing the heat transfer fluid into the circulation channels of all the gaps.

Thus, the circulation of the heat transfer fluid is organized so that this fluid circulates in contact with the large faces of the electricity storage cells. This facilitates particularly efficient cooling. Indeed, these cells comprise an external casing defining the large faces into which several windings are inserted. These windings consist of at least one cathode and anode set, separated by a separator. The windings are in contact with almost the entire surface of the large faces. During the charging and discharging of the electricity storage cell, mainly the windings that heat up and heat up the large surfaces of the cell by conductivity.

The separations make it possible to arrange a plurality of circulation channels in each gap and thus appropriately guide the heat transfer fluid in contact with the large faces so as to obtain excellent cooling of the electricity storage cells.

The distribution channels running under the cells enable both cooling of the undersides of the electrical storage cells and distribution of the heat transfer fluid into the circulation channels of all the gaps.

The electricity storage battery may further have one or more of the following features, considered individually or in any technically feasible combination:
in each gap, the separations are strips of plastic material resting on the two large faces delimiting the gap;
the battery comprises a partition in each gap, parallel to the two large faces delimiting the said gap, the separations each comprising at least one strip of plastic material placed on one side of the partition, preferably two strips of plastic material placed on either side of the partition, bearing on the two large faces;
in each gap the separations are reliefs provided in at least one of the large faces delimiting the gap;
the battery comprises a spacer structure placed on the bottom, the spacer structure comprising a plurality of profiles extending along the main direction, the profiles delimiting the distribution channels between them;
the battery comprises two lateral reinforcements for each set of electricity storage cells, extending in the main direction and delimiting a compartment between them, said set of electricity storage cells being located in the compartment with a space between the set of electricity storage cells and each lateral reinforcement, an adhesive resin filling the space and adhesively joining the electricity storage cells to the lateral reinforcements;
a wire is located in each space, the wire extending along the entire length of said space in the main direction and near the bottom;
the or each wire is of an electrically conductive, resistive metal and comprises a connection arranged to electrically connect the wire, selectively, to an electrical current source;
a lamina of a very low-density material is integrated into the adhesive resin in the or each space.

According to a second aspect, the disclosure relates to a vehicle comprising an electricity storage battery having the above features.

In some cases, one possibility is to arrange the circulation of the dielectric fluid so that it flows in contact with the three small faces of the electricity storage cells. Such a cooling method can be more efficient than traditional cooling systems for electricity storage batteries.

Further features and advantages of the present teaching will be apparent from the detailed description, given below by way of illustration and not limitation with reference to the appended figures.

### BRIEF DESCRIPTIONS OF THE DRAWINGS

FIG. 1 is a simplified schematic representation of a motor vehicle equipped with an electricity storage battery according to the disclosure;

FIG. 2 is a perspective view of the bottom of the electricity storage battery of FIG. 1, of part of a module and of the compartment provided for receiving this module inside the battery, with one of the reinforcements delimiting the compartment not shown in order to allow the cells to be seen more clearly, the cooling circuit of the electricity storage cells being shown schematically in this Figure;

FIG. 3 is a view similar to that of FIG. 2, with all the modules and compartments shown;

FIG. 4 is an enlarged perspective view of a detail from FIG. 2, with the reinforcements omitted, for clarity;

FIG. 5 is a sectional view perpendicular to the main direction, taken at the incidence of the arrows V in FIG. 2, with the reinforcements delimiting the compartment on both sides shown;

FIG. 6 is a view similar to that of FIG. 4, with one of the reinforcements and the wires for releasing the module, if applicable, being shown;

FIG. 7 is an exploded perspective view illustrating a variant embodiment of the present disclosure;

FIG. 8 is a simplified schematic view from above of two cells, showing another embodiment of the present disclosure; and

FIG. 9 is a simplified schematic view from above of a portion of a compartment, showing another variant embodiment of the present disclosure.

### DETAILED DESCRIPTION

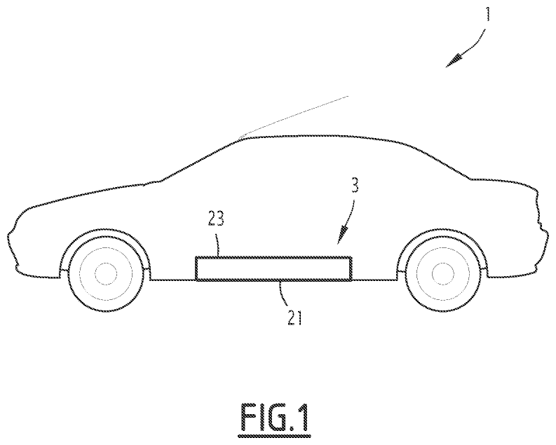

The vehicle 1 shown in FIG. 1 is equipped with an electricity storage battery 3.

This vehicle 1 is typically a motor vehicle such as a car, bus, truck, etc.

This vehicle is a vehicle propelled exclusively by an electric motor, for example, the motor being powered electrically by the electricity storage battery 3. In a variant, the vehicle is of the hybrid type and thus comprises an internal combustion engine and an electric motor powered electrically by the electric battery. According to another variant, the vehicle is propelled by an internal combustion engine, the electric battery being provided to electrically supply other equipment of the vehicle such as the starter, the lights, etc.

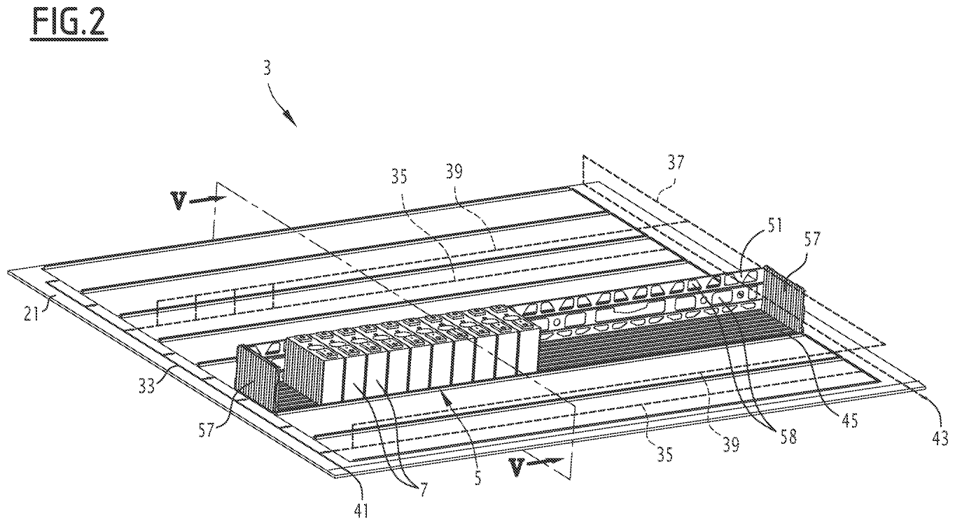

The electricity storage battery 3 comprises at least one set 5 of electricity storage cells 7, as visible in FIGS. 2 to 4.

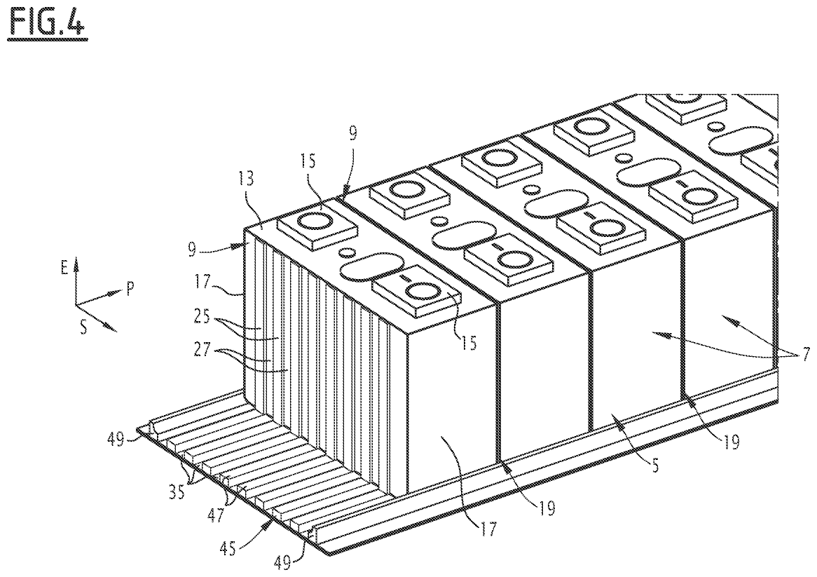

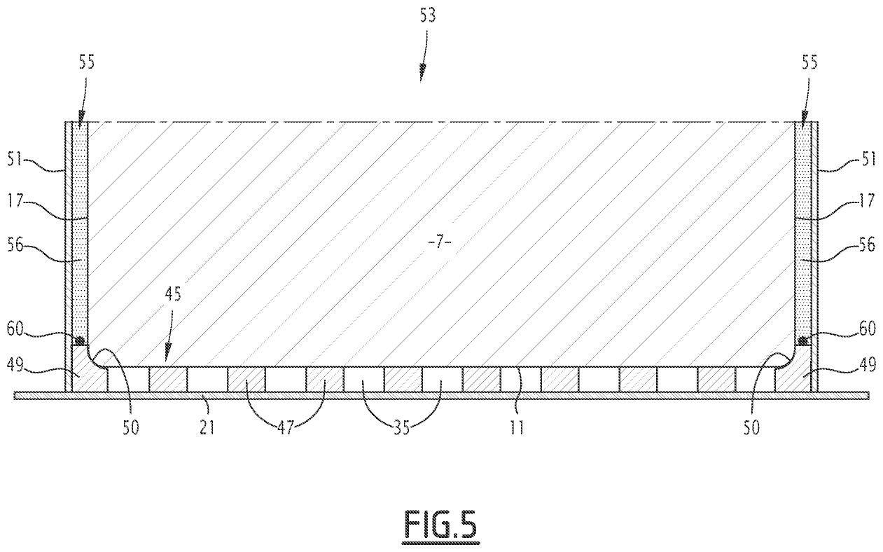

Each electricity storage cell 7 has two large faces 9 perpendicular to a main direction P (FIG. 4), and a bottom face 11 (FIG. 5) connecting the two large faces 9 to each other.

Each electricity storage cell 7 typically also has an upper face 13, connecting the two large faces 9 to each other, opposite the lower face 11. The top face 13 carries electrical contacts 15.

The electricity storage cell 7 further has two side faces 17 connecting the two large faces 9 to each other. The two side faces 17 are opposite each other.

Typically, the electricity storage cells 7 are prismatic in shape, with the side faces 17 being perpendicular to the large faces 9 and the bottom and top faces 11, 13. The bottom and top faces 11, 13 are perpendicular to the large faces 9.

The bottom and top faces 11, 13 are perpendicular to an elevation direction E shown in FIG. 4. The side faces 17 are perpendicular to a secondary direction S shown in FIG. 4.

The elevation direction E, the secondary direction S and the main direction P are perpendicular to each other.

The elevation direction E is generally perpendicular to the rolling plane of the vehicle 1 when the battery 3 is mounted onboard.

The top, bottom, height, upper and lower sides extend along the elevation direction E in this description.

The cells 7 of the at least one assembly 5 are aligned along the main direction P and constitute an alignment.

Two neighboring cells 7 in the alignment have opposing large faces 9, separated from each other by a gap 19.

In other words, each gap 19 is delimited along the main direction P by the large faces 9 of the two electricity storage cells 7 that flank it.

Each gap 19 extends substantially in a plane perpendicular to the main direction P.

The upper faces 13 carrying the electrical contacts 15 face the same side and are aligned along the main direction P.

The electrical contacts 15 of the different cells of the same assembly are connected to each other, so as to place the electricity storage cells 7 in series and/or in parallel. The connectors for connecting the electrical contacts of the cells are not shown in the figures.

Each assembly 5 thus has the general shape of a parallelepiped block, having an elongated shape along the main direction P.

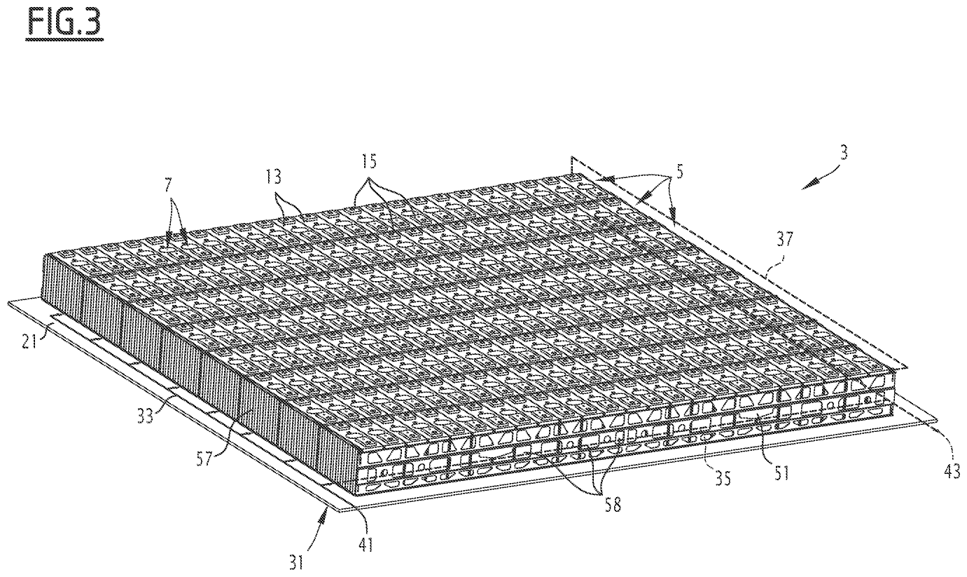

As visible in FIG. 3, the electricity storage battery 3 typically comprises several sets 5 of electricity storage cells.

These sets 5 are also commonly referred to as modules.

The number of assemblies 5 is based on the electricity storage capacity of the battery 3. In the example shown in FIG. 2, the battery comprises eight assemblies 5, each assembly 5 comprising twenty-four electricity storage cells 7. In a variant, the battery 3 comprises fewer than eight modules or more than eight modules. Each module may have fewer than twenty-four electrical storage cells 7 or more than twenty-four electrical storage cells 7.

In the example shown, the assemblies 5 are arranged side by side along the secondary direction S, and are all parallel to each other.

However, other configurations are possible. For example, the assemblies 5 could be arranged on a grid, each line of the grid comprising several assemblies 5 placed in line with each other along the main direction P, the lines of the grid being juxtaposed along the secondary direction S.

As clearly visible in FIGS. 1 to 3, the electricity storage battery 3 further comprises a bottom 21. The bottom 21 is in the form of a substantially flat plate in the example shown.

The bottom 21 extends under the electricity storage cells 7, opposite the bottom sides 11 of the electricity storage cells 7.

The bottom 21 is substantially perpendicular to the elevation direction E.

The electricity storage battery 3 further comprises a cover 23, visible in FIG. 1, with the bottom 21 and the cover 23 together forming an outer casing of the battery 3.

The bottom 21 and the cover 23 together define an internal volume in which the electricity storage cell assemblies 57 are housed.

The electricity storage battery 3 also comprises a plurality of separations 25 in each gap 19, delimiting between them a plurality of channels 27 for circulation of a heat transfer fluid in contact with the large faces 9 delimiting said gap 19.

In the same gap 19, the separations 25 all extend in the same direction. This direction here is the elevation direction E.

The separations 25 extend over the entire height of the gap 19, from the lower faces 11 to the upper faces 13 of the cells framing the gap 19.

The circulation channels 27 are therefore parallel to each other and also extend along the elevation direction E. They also extend over the entire height of the gap 19 and open out at both the bottom sides 11 and the top sides 13 of the two cells framing the gap 19.

The separations 25 are continuous, so that the circulation channels 27 do not communicate with each other.

In some embodiments, the separations 25 are strips of plastic material resting on the two large faces delimiting the gap 19.

Each separation 25 is made of polyurethane, for example, or polyamide, or polyethylene, or polypropylene, or any other suitable material.

The separations 25 are glued to one of the two large faces 9, and are simply pressed against the other large face 9, without being glued.

The separations 25 are as thin as possible in the main direction, so as not to increase the length of the assembly 5 excessively in the main direction.

The separations 25 are all identical to each other.

The separations 25 are independent of each other.

They do not touch each other. They are not directly attached to each other and are not integrated into a single piece of material. Instead, they are individually attached to the large faces 9 of the cells.

The dimensions and the number of separations 25 in the same gap 19 depend on the quantity of heat transfer fluid to be conveyed, on the one hand, and on the force in the main direction exerted on the cells, on the other hand. The force considered here is the force corresponding to the respiration of the electricity storage cells 7, and the force resulting from the acceleration of the vehicle in the main direction.

The respiration effort is due to the fact that the cells tend to swell in certain living situations, such as during rapid recharging. The acceleration is the result of normal vehicle motion or the result of impact to the vehicle in the event of an accident.

In any case, the dimensions and the number of separations 25 in the same gap are chosen so that these separations remain during the life of the electricity storage battery 3, and to guarantee the heat transfer fluid sufficient passage, so that the back pressure generated during the passage of the heat transfer fluid is moderate.

The flow rate of heat transfer fluid passing through the circulation channels 27 depends on the heat generated by the electricity storage cells 7, particularly in the event of rapid charging of the battery 3.

For example, for a battery having one hundred and ninety-two cells with an electricity storage capacity of 126 Ah, charged at a speed of 6 C (full charge of the battery in ten minutes), separations 25 having a thickness of 1 mm and a width of 5 mm are chosen, with the separations 25 spaced 10 mm apart along the secondary direction S. In other words, each flow channel 27 has a width of 10 mm and a thickness of 1 mm. In this case, the number of separations 25 is typically thirteen for twelve circulation channels 27.

Assuming that the maximum charging rate of the battery is 3 C (full charge of the battery in 20 min), separations 25 are provided, each having a width of 10 mm and a thickness of 0.8 mm, with the separations 25 spaced 7 mm apart along the secondary direction S. In other words, the flow channels 27 each have a width of 7 mm and a thickness of 0.8 mm.

The electricity storage battery 3 further comprises a circuit 31 for cooling the electricity storage cells 7.

This circuit is shown schematically in FIGS. 2 and 3.

The cooling circuit 31 comprises an upstream collector 33 and a plurality of distribution channels 35 fluidly connected to the upstream collector 33.

The cooling circuit 31 comprises a set of distribution channels 35 for each set 5 of electricity storage cells.

For each set 5 of electricity storage cells, the distribution channels 35 extend along the main direction P and are provided between the bottom 21 and the bottom faces 11 of the electricity storage cells 7 (see FIGS. 4 and 5). The distribution channels 35 distribute the heat transfer fluid into the circulation channels 27 of all the gaps 19 of said assembly 5.

The cooling circuit 31 further comprises a downstream collector 37 and a sub-collector 39, for each assembly 5, for collecting the heat transfer fluid, fluidly connected to the downstream collector 37. The circulation channels 27 of all the gaps of a single assembly 5 open into the sub-collector 39 related to said assembly.

The sub-collectors 39 of all the assemblies 5 are connected in parallel to the downstream collector 37.

The sub-collectors 39 extend in the main direction above the top faces 13.

The upstream collector 33 and the downstream collector 37 are provided along two opposite edges of the bottom 21.

They both extend along the secondary direction S.

According to one example embodiment, the upstream collector 33 is fluidly connected to a heat transfer fluid inlet 41 in the battery, and the downstream collector 37 is fluidly connected to a heat transfer fluid outlet 43 outside of the battery.

The inlet 41 and outlet 43 are intended to be connected to an on-board cooling circuit on the vehicle, typically comprising a heat transfer fluid circulator and a heat exchanger. The heat exchanger is provided to remove the heat generated by the electricity storage battery 3. The circulator sets the heat transfer fluid in motion. The discharge thereof is fluidly connected to the inlet 41, and the suction thereof to the outlet 43.

In a variant, the heat exchanger and the circulator are integrated in the electricity storage battery 3. In this case, the downstream collector 37 is fluidly connected to a heat exchanger inlet, the upstream collector 33 being fluidly connected to the discharge of the circulator. The suction of the circulator is connected to the outlet of the heat exchanger.

The heat transfer fluid is typically a dielectric liquid, such as an oil. In a variant, the heat transfer fluid is a gas.

As seen in FIG. 5, the electricity storage battery 3 can comprise a spacer structure 45 placed on the bottom 21. The spacer structure 45 comprises a plurality of profiles 47, 49 extending along the main direction P, the profiles 47, 49 delimiting the distribution channels 35 between them.

Each gap 19 has a first number N1 of circulation channels 27.

This first number N1 is the same for all the gaps 19. In other words, the gaps 19 all have the same number of circulation channels 27.

The cooling circuit 31 comprises exactly said first number N1 of distribution channels 35 for each set of electricity storage cells 5.

In other words, for each set 5, the cooling circuit 31 has a number N1 of distribution channels 35 equal to the number of circulation channels 27.

Each distribution channel 35 extends substantially along the entire length of the assembly 5, along the main direction.

Each distribution channel 35 feeds a circulation channel 27 of each gap 19 of the assembly 5.

The spacer structure 45 has as many profiles 47, 49 as there are partitions 25 in each gap 19.

The profiles 47 are placed coincident with the separations 25, along the secondary direction S. In other words, the profiles 47, 49 have substantially the same width along the direction S as the separations 25, and have the same spacing between them as the separations 25.

Only the profiles 49 located on the two sides of the spacer structure have a different shape, which will be described later. These profiles are called lateral profiles 49 here, the other profiles being called central profiles 47.

Thus, each heat transfer fluid stream circulating from the upstream collector 33 to the downstream collector 37 follows a path of equal length. This avoids creating preferential circulation areas inside the battery, with the heat transfer fluid being distributed uniformly between the different assemblies 5 and within the same assembly 5 between the different gaps 19, and in each gap 19 between the different circulation channels 27.

The distribution channels 35 are closed on one side by the bottom 21. They are open on the opposite side from the bottom 21.

The electricity storage cells 7 rest on the spacer structure 45, and more precisely on the profiles 47, 49. The edges 50 of the cells rest on the side profiles 49. The edges 50 extend between the side faces 17 and the bottom face 11 at the junction. They are rounded, as visible in FIG. 5.

The circulation channels 27 of each gap 19 are each placed coincident with one of the distribution channels 35 and open into it from their lower ends.

The distribution channels 35 are connected by a first end to the upstream collector 33. They are closed at their second ends. The first and second ends are opposite each other along the main direction P.

As can be seen in FIG. 5, the side profiles 49 located on both sides of the spacer structure 45 have a greater height, along the elevation direction E, than the central profiles 47, located between the side profiles 49.

The central profiles 47 all have the same height.

Furthermore, the profiles 47, 49 are made of a distortable plastic material, for example polyurethane or possibly expanded polypropylene.

This plastic material is rigid enough to support the mass of the electricity storage cells 7, but flexible enough so that the side profiles 49 follow the shape of the edges 50 of the cells, when the cells 7 are placed on the profiles 47, 49. A seal of the heat transfer fluid along the edges 50 is thus created.

The profiles 47, 49 are connected to each other by bars arranged in the distribution channels 35. These bars are not shown.

In some embodiments, the spacer structure 45 is made by molding or by injection molding, for example.

The electricity storage battery 3 further comprises two lateral reinforcements 51 for the or each set 5 of electricity storage cells, extending along the main direction and delimiting between them a compartment 53. The said assembly 5 is arranged in the compartment 53, with a space 55 between the assembly 5 and each lateral reinforcement 51.

In FIG. 2, only one of the reinforcements 51 has been shown.

The battery 3 also comprises two end reinforcements 57 for the or each assembly 5, visible in FIG. 2, delimiting the compartment 53 at its two ends. The reinforcements 57 are placed at both ends of the compartment 53 along the main direction P.

The lateral reinforcements 51 are housed inside the battery casing.

Similarly, the end reinforcements 57 are housed inside the battery casing.

The side reinforcements 51 are parallel to each other and perpendicular to the secondary direction S. The end reinforcements 57 are parallel to each other and perpendicular to the primary direction P.

The side reinforcements 51 are rigidly attached to the bottom 21.

Likewise, the end reinforcements 57 are rigidly attached to the bottom 21, and are preferably rigidly attached to the side reinforcements 51.

The side reinforcements 51 are metal plates, preferably having holes 58. They extend along the entire length of the assembly 5 and extend slightly beyond it.

Similarly, the end reinforcements 57 are metal plates, extending across the width of the assembly 5 and extending slightly beyond it.

Holes, not shown, are provided along the lower edge of one of the end walls 57, so as to allow communication between the distribution channels 35 and the upstream collector 33.

As visible in FIG. 5, the spaces 35 are closed downwardly, i.e. toward the bottom 21, by the side profiles 49. These lateral profiles 49 rest against the lateral reinforcements 51 on one side, and against the edge 50 of each cell 53 on the other side.

Furthermore, as seen in FIG. 4, a separation 25 is placed on both sides of the gap 19, along the edge connecting each lateral face 17 to the large face 9. These separations 25 isolate the gap 19 from the space 55.

In some embodiments, and as visible in FIG. 5, an adhesive resin 56 fills each space 55, and adhesively attaches the electricity storage cells 7 to each lateral reinforcement 51.

In fact, each space 55 extends continuously along the entire length of the compartment 53, this length being taken along the main direction.

The adhesive resin 56 thus attaches the side faces 17 of each electricity storage cell 7 to the lateral reinforcements 51 located opposite, by adhesion.

This adhesive resin is can be an elastic polymer, typically polyurethane.

It is typically poured into each space 55. Once polymerized, it is strong enough to hold the electricity storage cells 7 in place.

It makes adhesion between 2 and 25 MPa possible, preferably between 3 and 10 MPa and even more preferably about 5 MPa.

The elastic adhesive resin 56 completely fills each gap 55.

The adhesive resin 56 thus makes the battery more rigid overall and ensures that the electricity storage cells 7 are sufficiently held in place in all vehicle life situations in all directions, whether in the elevation direction E, the main direction P, or the secondary direction S.

As seen in FIGS. 2 to 5, the lateral reinforcements 51 are typically common to two compartments 53 arranged side by side. In other words, a given side reinforcement 51 delimits two compartments 53, arranged on opposite sides of that reinforcement.

In this case, one adhesive resin layer 56 is arranged between the side reinforcement 51 and the assembly 5 arranged in the one compartment 53, and another adhesive resin layer 56 is arranged between the side reinforcement 51 and the assembly 5 arranged in the other compartment 53. The adhesive resin layers 56 arranged on either side of the side reinforcement 51 meet through holes 58 in the reinforcement 51, which helps to enhance the rigidity of the battery.

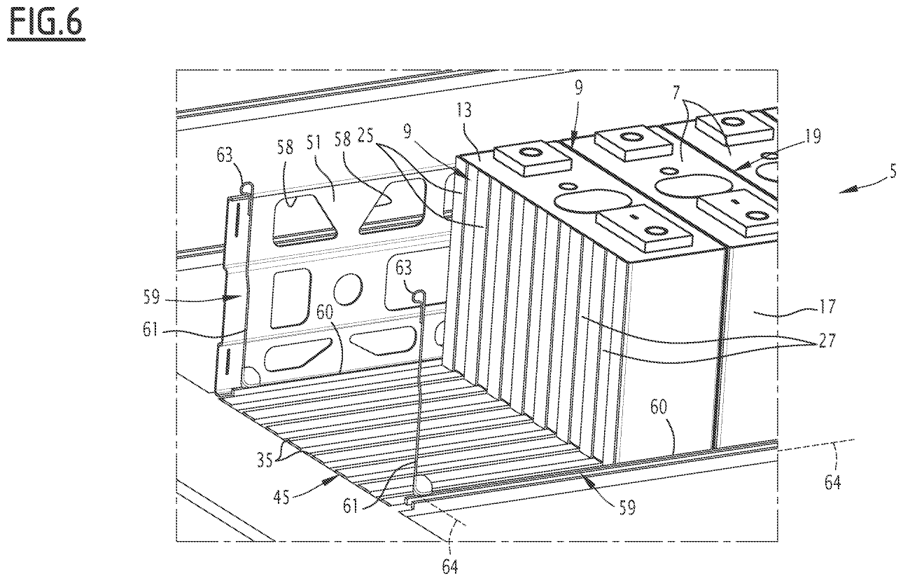

As seen in FIG. 6, a wire 59 can be arranged in each space 55.

The wire 59 comprises a main portion 60 that extends along the entire length of the space 55 in the main direction P, and passes close to the bottom 21.

For example, the main portion 60 extends along and in close proximity to the side profile 49 closing the gap 55 toward the bottom 21.

The main portion 60 extends into an end portion 61 terminating by a gripping member 63.

The end portion 61 is oriented along the elevation direction E and is located at one end of the compartment 53.

The gripping end 63 is a loop, for example, formed at the end of the terminal portion 61. This loop protrudes above the adhesive resin 56.

A user can thus grasp the gripping member 63 and pull the wire 59 upward, i.e. away from the bottom 21. This makes it possible to shear the adhesive resin 56 along the entire length of the gap 55 and separate the electrical storage cells 7 from the side reinforcement 51.

According to one variant, each wire 59 is made of a resistive metal that conducts electricity. It further comprises a connection 64 arranged to electrically connect the wire 59, selectively, to an electrical power source.

The source of the current is the battery itself or is external to the battery.

Thus, it is possible to reduce the pulling effort by using a resistive wire through which an electric current will be passed, the passage of the electric current will heat the wire, which will degrade the adhesive resin in contact therewith.

Preferably, other spaces are provided between the end reinforcements 57 and the cells 7 located at the ends of the cell alignment. These end spaces are also filled with adhesive resin, so that the end cells of the alignment are bonded to the end reinforcements 57.

Wires of the same type as the wires 59 are placed in these end spaces to make it possible to shear the adhesive and separate the end cells from the end reinforcements 57.

Typically, the wires 59 are placed in the spaces 55 before the adhesive resin 56 is poured.

It is notable that in the illustrated design, the adhesive resin is poured after the electricity storage cell assembly 5 has been placed in the compartment 53. This makes it possible to compensate easily for dimensional variations in the cells. The thickness of the adhesive resin varies. This method also makes it possible to reduce the requirements applicable to positioning and assembling the reinforcements 51 and 57.

In a variant, it is possible to overmold the adhesive on the reinforcements 51 and on the end reinforcements 57, before positioning the electricity storage cell assembly 5 in the cavity. In this case, the thickness of the adhesive layer must be very precisely controlled, and the adhesive layer must be sufficiently compressible to compensate for dimensional variations in the cells. This overmolding must take place after the spacer structure is in place.

The circulation of the heat transfer fluid in the battery will now be described.

The heat transfer fluid first flows through the upstream collector 33.

Typically, the upstream collector 33 is supplied by the heat transfer fluid inlet 41.

From the upstream collector 33, the heat transfer fluid flows into the distribution channels 35 serving each set 5 of electricity storage cells.

It flows under the cells 7 of this assembly, along each distribution channel 35. From each distribution channel 35, it is distributed into a circulation channel 27 of each gap 19.

Because each distribution channel 35 is closed at its end opposite the upstream collector 33, the fluid is forced to distribute itself entirely into the circulation channels 27 served by the distribution channel.

The heat transfer fluid, in the circulation channel 27, flows in contact with the large faces 9 delimiting the gap 19.

At the end of the circulation channel 27, the fluid is collected by the sub-collector 39, and is channeled by this sub-collector 39 to the downstream collector 37.

Typically, the downstream collector 37 channels the heat transfer fluid to the outlet 43.

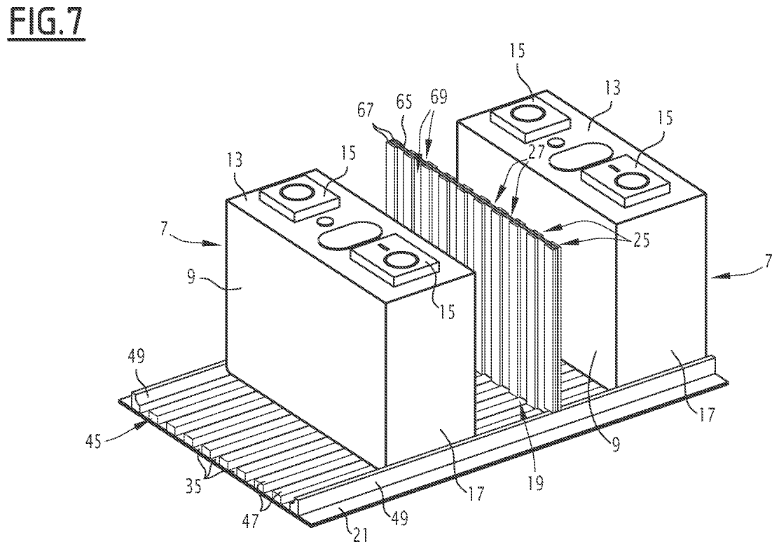

A variant embodiment of the disclosure will now be described, with reference to FIG. 7. Only the points by which this variant differs from that of FIGS. 1 to 6 will be detailed below. Elements that are identical or perform the same functions will be designated by the same references for both variants.

In the embodiment shown in FIG. 7, the electricity storage battery 3 comprises a partition 65, in each gap 19, parallel to the two large faces 9 delimiting said gap 19.

The separations 25, in this case, each comprise two strips of plastic material 67, placed on either side of the partition 65 and resting on the two large faces 9 framing the gap 19.

In other words, the partition 65 divides each separation 25 into two parts, corresponding to the two strips 67. Each strip 67 rests on one side on the partition 65 and on the other side on one of the two large faces 9.

Typically, the strips 67 are integral with the partition 65 and simply rest on the large faces 9.

The partition 65 divides the gap 19 into two equal parts. It has approximately the same size as the large faces 9 and is placed opposite them. It is arranged perpendicular to the main direction P.

The partition 65 is illustratively a metal sheet, typically of a steel.

The wall 65 has a thickness of between 0.5 mm and 1 mm, preferably between 0.075 mm and 0.3 mm, and typically 0.1 mm.

The flow channels 27 are also divided by the partition 65 into two sub-channels 69. One of the two subchannels 69 is delimited on one side by the partition 65 and on the other side by one of the large faces 9. The other subchannel 69 is delimited between the partition 65 and the other large face 9.

The total passage cross-section of the two sub-channels 69 is equal to the passage cross-section provided to the heat transfer fluid in the first embodiment.

The partition 65 acts as a firewall.

Indeed, if one of the electricity storage cells 7 starts to burn, there is a risk that the fire will spread to the neighboring cells. The heat transfer fluid circulating in the circulation channels helps extend the time before the fire spreads to the neighboring cells. Indeed, before spreading, the fire must first heat and destroy the fluid.

In addition, the distance, i.e. the spacing between the cells increases the time required for the fire to spread.

The addition of a partition, typically a steel partition, further contributes to delaying the spread. The partition forms a screen preventing the heat from spreading.

In some embodiments, the partition 65 is coated with a fireproofing or retarding agent.

The sheet metal 65 carrying the strips 67 can be obtained in different ways.

According to a first possibility, the material intended to constitute the strips is deposited directly on continuous sheet metal. The continuous sheet metal is then cut to the dimensions of the partition 65.

According to a second possibility, the strips 67 are rigidly fixed to the large faces 9, the bare partitions 65 being then mounted between the cells 7, in each gap 19.

According to a third possibility, the strips 67 are pre-formed. They are then fixed by any suitable means, such as by gluing, to a continuous sheet. The continuous sheet is then cut to the dimensions of the partition 65.

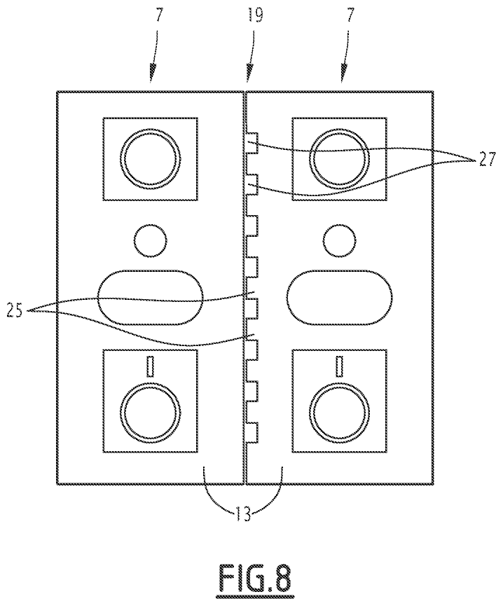

A third variant will now be described, with reference to FIG. 8. Only the points in which this third variant differs from the first will be detailed below. The same elements or those performing the same function will be designated by the same references in the two variants.

In the variant embodiment of FIG. 8, in each gap 19, the separations 25 are reliefs, formed in at least one of the large faces 9 delimiting the gap 19.

In other words, at least one of the large faces 19 is distorted so as to form projecting ribs constituting the separations 25, with the recessed portions between the ribs constituting the flow channels 27.

In FIG. 8, only one of the large faces 9 has projecting ribs. In a variant, both large faces 9 have projecting ribs facing each other. The separations 25 are formed by the projecting ribs of the two large faces, located opposite each other. The flow channels 27 are formed together by the recesses of the two large faces, between the projecting ribs.

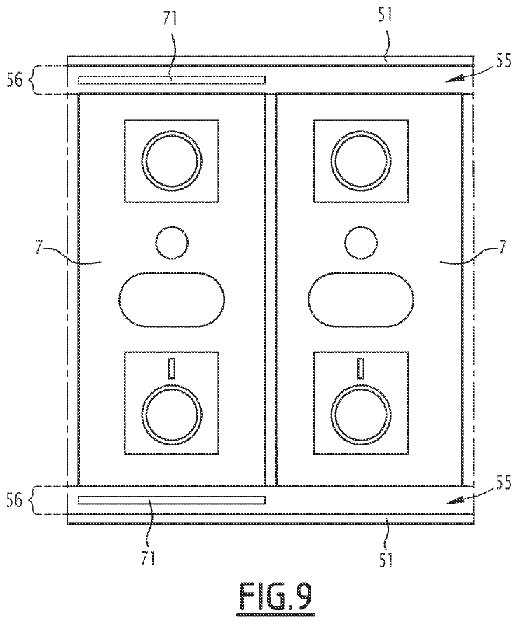

A fourth variant embodiment will now be described, with reference to FIG. 9. Only the points in which this fourth variant differs from the first will be detailed below. Identical elements or elements performing the same function will be designated by the same references in the two variants.

In the fourth embodiment, the battery does not have a wire arranged in the space 55. Instead, a lamina 71 of a very low-density material is embedded in the adhesive resin 56 in each space 55.

The very low-density material is typically a foam, such as a polyurethane foam.

In some embodiments, the very low-density material has a density lower than the adhesive resin, preferably less than 40 kg/m³.

The lamella 71 extends over the entire height of the space 55, in the elevation direction.

For example, it has a width of about 20 mm in the main direction.

It has, for example, a thickness of 1 to 2 mm in the secondary direction.

Such a lamella is also integrated in the adhesive resin layer between each end cell and the corresponding reinforcement 57.

This lamella is provided to enable insertion of a blade or saw adapted to cut the elastic adhesive resin.

The electricity storage battery has multiple potential advantages.

The fact that the separations all extend along the same secondary direction, perpendicular to the main direction, in the same gap, makes it possible to organize a heat-transfer fluid circulation that ensures effective cooling of the large faces without excessive back pressure.

The fact that each gap has a number of circulation channels equal to the number of distribution channels makes it possible to organize an effective and homogeneous distribution of the heat transfer fluid in the distribution channels without concentration of the flow in certain areas.

Making the separations as plastic strips resting on the two large faces delimiting the gap is particularly simple and convenient.

Placing a partition in each gap parallel to the two large faces delimiting the gap makes it possible to increase safety vis-à-vis the risk of fire, as explained above.

Making the separations as reliefs in at least one of the large faces delimiting the gap makes it easier to assemble the electricity storage cell assemblies.

Using a spacer structure placed on the bottom, the spacer structure comprising a plurality of profiles extending along the main direction, makes it convenient and inexpensive to make the distribution channels.

The adhesive resin, bonding the electricity storage cells to the struts, makes it possible to reinforce the battery structure.

Providing a wire in each space filled with adhesive resin makes it possible to separate the cells from the reinforcements conveniently, and thus replace the cells.

The electricity storage battery has multiple variants.

It has been described in the above examples as having a plurality of sets of electricity storage cells. In a variant, it has only one.

The distribution channels might not be made in the form of a spacer, but might be made directly in the bottom.

The battery might be free of adhesive resin, or the adhesive resin could be replaced by a non-adhesive elastic material.

1. A battery for storing electricity, the battery comprising:
at least one set of electricity storage cells each having two large faces perpendicular to a main direction and a bottom face connecting the two large faces to each other, the electricity storage cells being aligned along the main direction and forming an alignment, two electricity storage cells adjacent in the alignment having facing large faces, separated from each other by a gap;
in each gap, a plurality of separations delimiting between them a plurality of channels for circulation of a heat transfer fluid in contact with the large faces delimiting the gap;
a bottom extending under the electricity storage cells, opposite the lower faces of the electricity storage cells; and
a circuit for cooling the electricity storage cells, the circuit comprising an upstream collector and a plurality of distribution channels fluidly connected to the upstream collector, the distribution channels extending in the main direction and provided between the bottom and the lower faces of the electricity storage cells, the distribution channels distributing the heat transfer fluid into the circulation channels of all the gaps

2. The electricity storage battery according to claim 1, wherein the separations in each gap are plastic strips abutting the two large faces delimiting the gap.

3. The electricity storage battery according to claim 1, in which the battery comprises a partition in each gap, parallel to the two large faces delimiting said gap, the separations each comprising at least one strip of plastic material placed on one side of the partition).

4. The electricity storage battery according to claim 1, wherein the separations in each gap are reliefs provided in at least one of the large faces delimiting the gap.

5. The electricity storage battery according to claim 1, in which the battery comprises a spacer structure placed on the bottom, the spacer structure comprising a plurality of profiles extending along the main direction, the profiles delimiting the distribution channels between them.

6. The electricity storage battery according to claim 1, in which the battery comprises two lateral reinforcements for each set of electricity storage cells, extending along the main direction (P) and delimiting a compartment between them, said assembly of electricity storage cells being arranged in the compartment with a space between the assembly (5) of electricity storage cells and each lateral reinforcement, an adhesive resin filling the space and adhesively attaching the electricity storage cells to the lateral reinforcements.

7. The electricity storage battery of claim 6, wherein a wire is arranged in each space, the wire extending along the entire length of said space in the main direction and near the bottom.

8. The electricity storage battery of claim 7, wherein the or each wire is of an electrically conductive resistive metal and comprises a connection arranged to electrically connect the wire, selectively, to a source of electrical power.

9. The electricity storage battery of claim 6, wherein a lamina of a very low-density material is embedded in the adhesive resin, in the or each gap.

10. The electricity storage battery of claim 3, wherein the separations each comprise two strips of plastic material placed on either side of the partition and resting on the two large faces.

11. A vehicle comprising an electricity storage battery according to claim 1.
